(19) United States
(12) Patent Application Publication
(10) Pub. No.: US 2016/0062190 A1
(43) Pub. Date: Mar. 3, 2016

(54) LIQUID CRYSTAL DISPLAY APPARATUS

(71) Applicant: Samsung Display Co., LTD., Yongin-City (KR)

(72) Inventors: Cheol Shin, Yongin-City (KR); Haksun Chang, Yongin-City (KR); Kaeun Kim, Yongin-City (KR); Sehyun Lee, Yongin-City (KR); Kichul Shin, Yongin-City (KR)

(21) Appl. No.: 14/696,153

(22) Filed: Apr. 24, 2015

(30) Foreign Application Priority Data
Aug. 28, 2014 (KR) 10-2014-0113352

(51) Int. Cl. G02F 1/1343

(52) U.S. Cl. CPC G02F 1/134309; G02F 1/13439; G02F 2001/134345

(57) ABSTRACT

An LCD apparatus includes a a pixel electrode including a first subpixel electrode and a second subpixel electrode, to which a voltage lower than a voltage applied to the first subpixel electrode is applied and which forms a predetermined space with the first subpixel electrode and surrounds the first subpixel electrode, a common electrode having a cross-type opening pattern, and a liquid crystal layer. The first subpixel electrode includes, a first plate electrode, a plurality of first branch electrodes protruding from sides of the first plate electrode, a trunk electrode extending from a corner of the first plate electrode in a lengthwise direction of the cross-type opening pattern and having a trunk surface that faces one end portion of the cross-type opening pattern and is inclined at a predetermined angle with respect to the lengthwise direction, and a plurality of second branch electrodes protruding from sides of the trunk electrode.

### CLAIM OF PRIORITY

This application claims the benefit of Korean Patent Application No. 10-2014-0113352, filed on Aug. 28, 2014, in the Korean Intellectual Property Office, the disclosure of which is incorporated herein in its entirety by reference.

### BACKGROUND OF THE INVENTION

1. Field of the Invention

One or more embodiments of the present invention relate to liquid crystal display (LCD) apparatuses.

2. Description of the Related Art

A LCD apparatus is one of the most widely used flat panel display apparatuses. The LCD apparatus includes: two substrates on which field generating electrodes such as pixel electrodes and common electrodes are formed; and a liquid crystal layer interposed between the two substrates. The LCD apparatus applies a voltage to the field generating electrodes to generate an electric field in the liquid crystal layer and thus determines the direction of liquid crystal molecules of the liquid crystal layer, and controls the polarization of incident light to display an image.

Examples of the LCD apparatus include a vertically aligned mode LCD apparatus that drives a liquid crystal by using a vertical electric field that is formed in a vertical direction of a substrate, and an in-plane switching mode LCD apparatus that drives a liquid crystal by using a horizontal electric field that is parallel to a substrate.

The vertically aligned mode LCD apparatus has a high contrast ratio, and attempts have been made to design various pattern electrodes in order to ensure a wide viewing angle and increase an aperture ratio.

### SUMMARY OF THE INVENTION

One or more embodiments of the present invention include liquid crystal display (LCD) apparatuses with a reduced texture and an improved transmittance.

Additional aspects will be set forth in part in the description which follows and, in part, will be apparent from the description, or may be learned by practice of the presented embodiments.

According to one or more embodiments of the present invention, a liquid crystal display apparatus includes a first substrate on which a pixel electrode including a first subpixel electrode and a second subpixel electrode, to which a voltage lower than a voltage applied to the first subpixel electrode is applied and which forms a predetermined space with the first subpixel electrode and surrounds the first subpixel electrode, is formed, a second substrate on which a common electrode having a cross-type opening pattern is formed, and a liquid crystal layer disposed between the first substrate and the second substrate. The first subpixel electrode includes a first plate electrode, a plurality of first branch electrodes protruding from four sides of the first plate electrode, a trunk electrode extending from a corner of the first plate electrode in a lengthwise direction of the cross-type opening pattern and having a trunk surface that faces one end portion of the cross-type opening pattern and is inclined at a predetermined angle with respect to the lengthwise direction, and a plurality of second branch electrodes protruding from both sides of the trunk electrode.

The trunk electrode may be provided in plurality and may be formed at each of two opposite corners of the first plate electrode.

The pixel electrode may be repeatedly arranged in one direction, and the trunk electrode may be formed at each of two corners that are arranged in a direction perpendicular to the one direction.

The second subpixel electrode may include: a second plate electrode forming a predetermined space with the first subpixel electrode and surrounding the first subpixel electrode; and a plurality of third branch electrodes extending from an outer frame of the second plate electrode.

A shape connecting end portions of the plurality of third branch electrodes and the second plate electrode may be a chamfered quadrangle shape.

A center portion of the cross-type opening pattern may form a diamond-type opening.

The predetermined space may be about 3 μm or less.

A shape connecting end portions of the plurality of first branch electrodes, the trunk electrode, and the plurality of second branch electrodes may be a diamond shape.

According to one or more embodiments of the present invention, a liquid crystal display apparatus includes a first substrate on which a pixel electrode including a first subpixel electrode and a second subpixel electrode, to which a voltage lower than a voltage applied to the first subpixel electrode is applied and which forms a predetermined space with the first subpixel electrode and surrounds the first subpixel electrode, is formed, a second substrate on which a common electrode having a cross-type opening pattern is formed, and a liquid crystal layer disposed between the first substrate and the second substrate, wherein the first subpixel electrode includes a first plate electrode a portion of which facing one end of the cross-type opening pattern has a chamfered shape.

A chamfered surface of the chamfered shape may be perpendicular to a lengthwise direction of the cross-type opening pattern.

The chamfered shape may be formed at two opposite corner portions of the first plate electrode.

A center portion of the cross-type opening pattern may have a diamond shape.

The pixel electrode may be repeatedly arranged in one direction, and the chamfered shape may be formed at each of two corner portions that are arranged in a direction perpendicular to the one direction.

The second subpixel electrode may include: a second plate electrode forming a predetermined space with the first subpixel electrode and surrounding the first subpixel electrode; and a plurality of branch electrodes extending from an outer frame of the second plate electrode.

A portion of the second subpixel electrode, which faces a chamfered surface of the chamfered shape of the first subpixel electrode, may be parallel to the chamfered surface.

A shape connecting end portions of the plurality of branch electrodes and the second plate electrode may be a chamfered quadrangle shape.

The predetermined space may be about 3 μm or less.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view illustrating a schematic structure of a liquid crystal display (LCD) apparatus according to an embodiment of the present invention;

FIG. 2 is a plan view illustrating in detail an electrode structure of the LCD apparatus of FIG. 1;

FIGS. 3A and 3B are plan views respectively illustrating a common electrode and a pixel electrode in the plan view of FIG. 2;

FIG. 4 is an enlarged view of a partial region of FIG. 3B;

FIG. 5 is an enlarged view of a partial region of a pixel electrode according to a comparative example;

FIG. 6 illustrates a direction of a fringe field generated in a local region of FIG. 4;

FIG. 7 illustrates a direction of a fringe field generated in a local region of FIG. 5 by the pixel electrode according to the comparative example;

FIG. 8 illustrates a texture pattern generated in the local region of FIG. 4 in the LCD apparatus according to an embodiment of the present invention;

FIG. 9 illustrates a texture pattern generated in the local region of FIG. 5 by the pixel electrode according to the comparative example;

FIG. 10 is a cross-sectional view illustrating a schematic structure of a LCD apparatus according to another embodiment of the present invention;

FIG. 11 is a plan view illustrating in detail an electrode structure of the LCD apparatus of FIG. 10;

FIGS. 12A and 12B are plan views respectively illustrating a common electrode and a pixel electrode in the plan view of FIG. 11;

FIG. 13A is an enlarged view of a partial region of FIG. 2;

FIG. 13B is a cross-sectional view taken along an indication line of FIG. 13A, which illustrates a direction of a force applied to a liquid crystal layer;

FIG. 14A is an enlarged view of a partial region A of FIG. 11;

FIG. 14B is a cross-sectional view taken along an indication line of FIG. 14A, which illustrates a direction of a force applied to a liquid crystal layer;

FIG. 15 is a plan view illustrating an electrode structure of a LCD apparatus according to a comparative example;

FIG. 16 illustrates a texture pattern generated in the LCD apparatus of FIG. 10; and

FIG. 17 illustrates a texture pattern generated in the LCD apparatus according to the comparative example.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

The present invention may include various embodiments and modifications, and exemplary embodiments thereof are illustrated in the drawings and will be described herein in detail. The effects and features of the present invention and the accomplishing methods thereof will become apparent from the following description of the embodiments, taken in conjunction with the accompanying drawings. However, the prevent invention is not limited to the embodiments described below, and may be embodied in various modes.

Hereinafter, embodiments of the present invention will be described in detail with reference to the accompanying drawings. In the following description, like reference numerals denote like elements, and redundant descriptions thereof will be omitted.

It will be understood that although the terms “first”, “second”, etc. may be used herein to describe various components, these components should not be limited by these terms. These terms are only used to distinguish one component from another.

As used herein, the singular forms “a”, “an” and “the” are intended to include the plural forms as well, unless the context clearly indicates otherwise.

It will be further understood that the terms “comprise”, “include” and “have” used herein specify the presence of stated features or components, but do not preclude the presence or addition of one or more other features or components.

It will be understood that when a layer, region, or component is referred to as being “formed on” another layer, region, or component, it may be directly or indirectly formed on the other layer, region, or component. That is, for example, intervening layers, regions, or components may be present.

Sizes of components in the drawings may be exaggerated for convenience of description. In other words, since sizes and thicknesses of components in the drawings are arbitrarily illustrated for convenience of description, the following embodiments are not limited thereto.

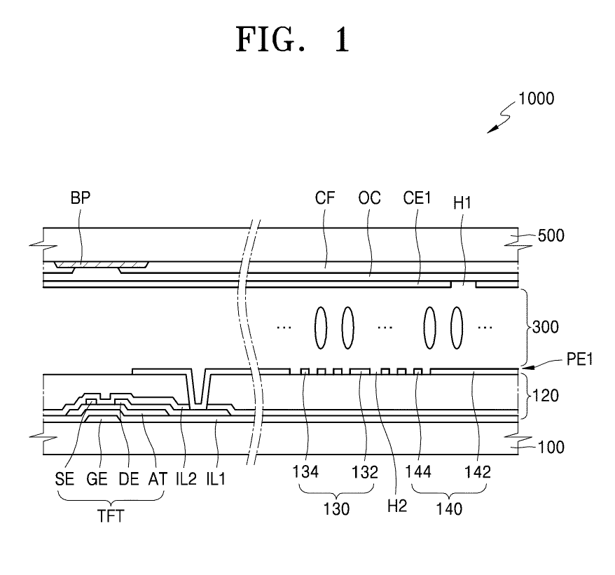

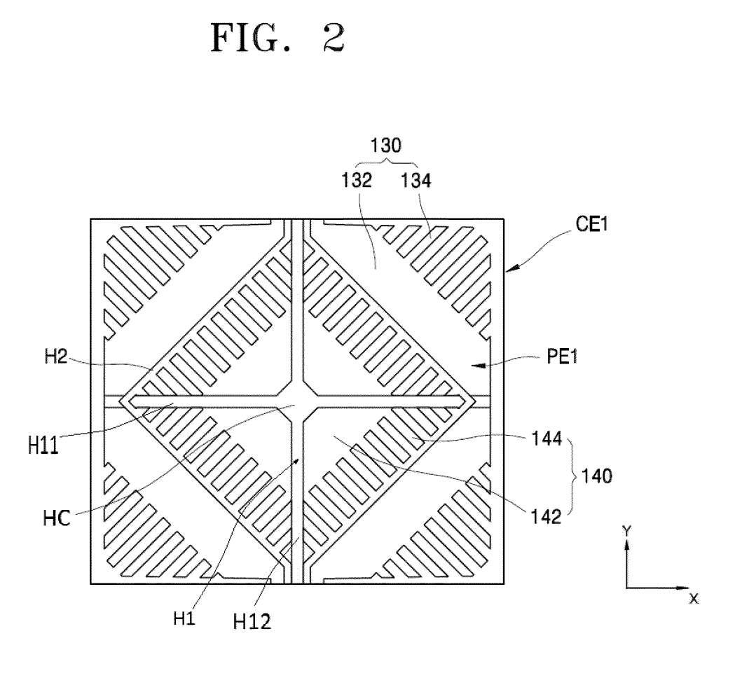

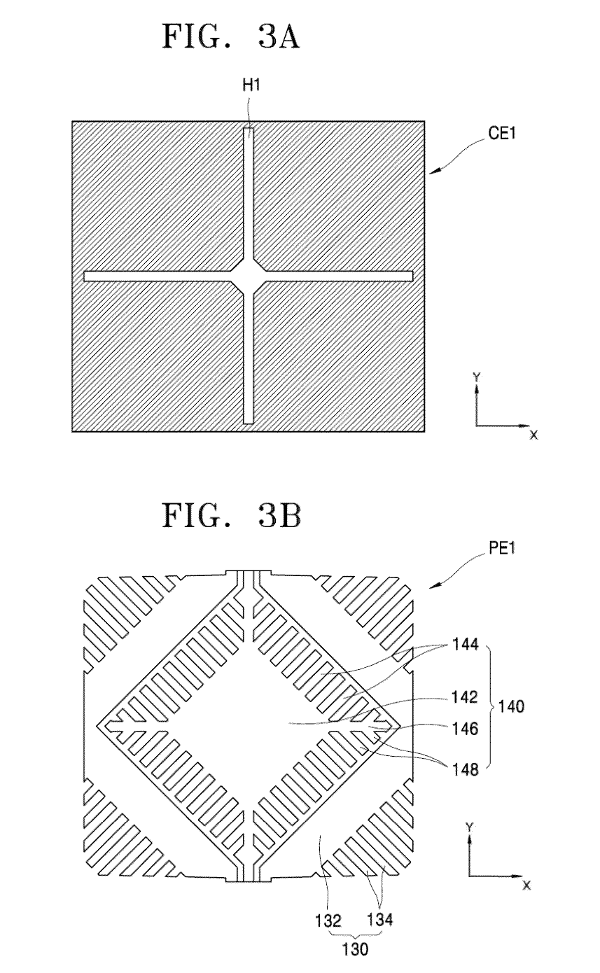

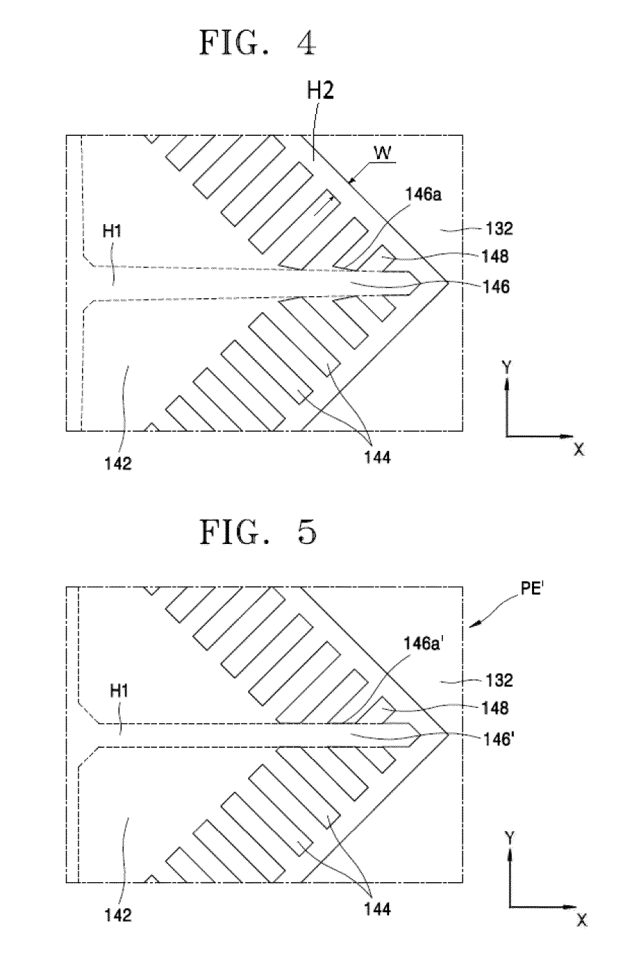

FIG. 1 is a cross-sectional view illustrating a schematic structure of a liquid crystal display (LCD) apparatus 1000 according to an embodiment of the present invention. FIG. 2 is a plan view illustrating in detail an electrode structure of the LCD apparatus 1000 of FIG. 1. FIGS. 3A and 3B are plan views respectively illustrating a common electrode and a pixel electrode in the plan view of FIG. 2. FIG. 4 is an enlarged view of a partial region of FIG. 3B.

The LCD apparatus 1000 includes a first substrate 100 on which a pixel electrode PE1 is formed, a second substrate 500 on which a common electrode CE1 is formed, and a liquid crystal layer 300 disposed between the first substrate 100 and the second substrate 500.

According to an exemplary embodiment, the LCD apparatus 1000 is a vertically aligned mode LCD apparatus that drives a liquid crystal by using a vertical electric field formed in a vertical direction of a substrate, and is a patterned vertical alignment (PVA) mode LCD apparatus in which minute slit patterns are formed in the pixel electrode PE1 and the common electrode CE1 in order to realize a wider viewing angle.

Shapes of the common electrode CE1 and the pixel electrode PE1 will be described in detail below.

Referring to FIGS. 2 and 3A, a cross-type opening pattern H1 is formed in the common electrode CE1. The cross-type opening pattern H1 includes a first portion H11 extending in a first direction X and a second potion H12 extending in a second direction Y and intersected by the first portion H11 at a center portion HC of the cross-type opening pattern H1. The center portion HC of the cross-type opening pattern H1 may have a diamond shape as illustrated in FIGS. 2 and 3A, but is not limited thereto.

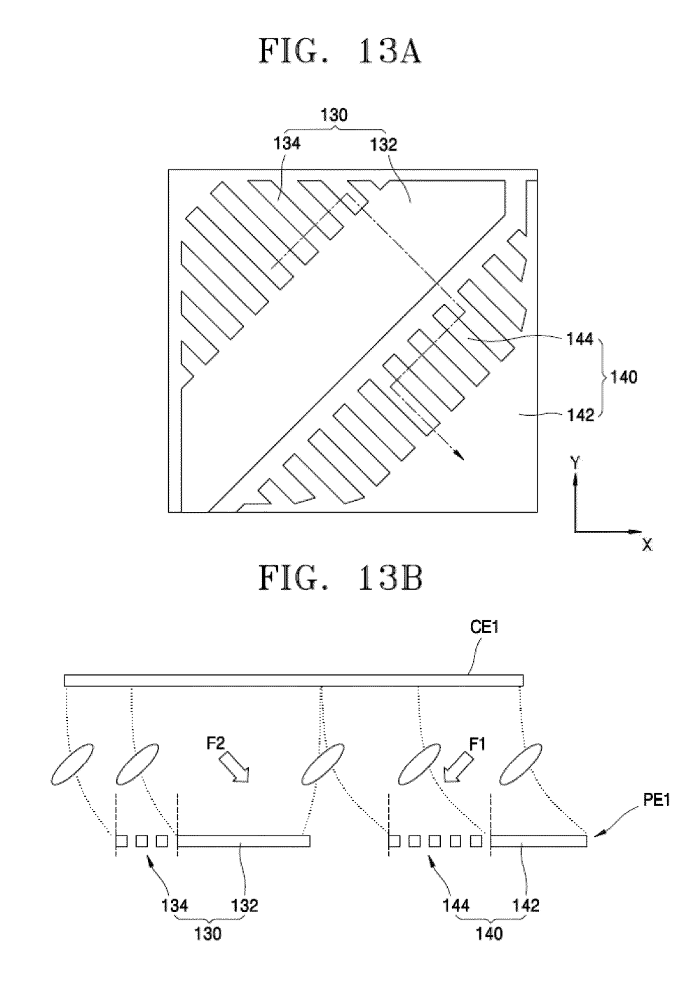

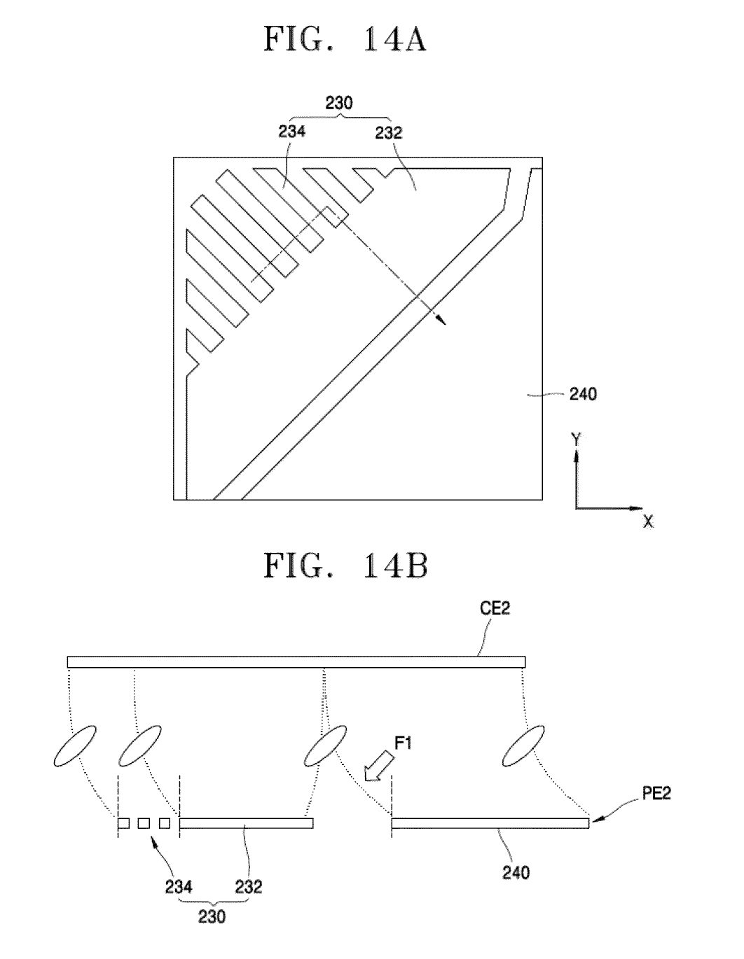

Referring to FIGS. 2 and 3B, the pixel electrode PE1 includes a first subpixel electrode 140 and a second subpixel electrode 130. A voltage lower than a voltage applied to the first subpixel electrode 140 is applied to the second subpixel electrode 130. For example, a first voltage, with reference to a reference voltage, is applied to the first subpixel electrode 140 of the pixel electrode PE1, and a second voltage, with reference to the same reference voltage, is applied to the second subpixel electrode 130 of the same pixel electrode PE1. The reference voltage of the first and second voltages may be applied to the common electrode CE1 of the same pixel. The first voltage is different from the second voltage. Here, the first voltage is greater than the second voltage. As shown in FIGS. 2, 13A, and 13B, the first subpixel electrode 140 and the second subpixel electrode 130 are electrically isolated from each other. A method of dividing a pixel electrode into two subpixel electrodes and applying different voltages to the two subpixel electrodes as above is used to approximate lateral side visibility to front visibility. A spacing distance between the first subpixel electrode 140 and the second subpixel electrode 130 and a ratio between voltages applied to the first subpixel electrode 140 and the second subpixel electrode 130 may be adjusted to improve the lateral side visibility.

The first subpixel electrode 140 includes a first plate electrode 142, and a plurality of first branch electrodes 144 protruding from four sides of the first plate electrode 142. Also, the first subpixel electrode 140 further includes a trunk electrode 146 protruding from four corners of the first plate electrode 142, and a plurality of second branch electrodes 148 protruding from opposite sides of the trunk electrode 146. The trunk electrode 146 extends in a lengthwise direction, such as the X direction or the Y direction (dependent on where the trunk electrode 146 is located with respect to the center portion HC), of the cross-type opening pattern H1 formed in the common electrode CE1, and has a trunk surface 146a inclined at a predetermined angle with respect to the lengthwise direction of the cross-type opening pattern H1. The predetermined angle is not equal to zero or 180°. The plurality of second branch electrodes 148 protrude from the trunk surface 146a. A region between the plurality of second branch electrodes 148 is a minute slit that has the inclined trunk surface 146a as an end portion thereof. The trunk electrode 146 may be provided in a plurality and may be formed at each of two opposite corners of the first plate electrode 142 as illustrated in the drawings.

A shape connecting the end portions of the plurality of first branch electrodes 144, the trunk electrode 146, and the plurality of second branch electrodes 148 may be a diamond shape. However, embodiments of the present invention are not limited thereto.

The second subpixel electrode 130 forms a predetermined space with the first subpixel electrode 140 with a slit H2 interposed therebetween. The second subpixel electrode 130 includes a second plate electrode 132 surrounding the first subpixel electrode 140, and a plurality of third branch electrodes 134 extending from an outer frame of the second plate electrode 132.

A shape connecting the end portions of the plurality of third branch electrodes 134 and the second plate electrode 132 may be a chamfered quadrangle shape, but is not limited thereto.

The spacing distance between the first subpixel electrode 140 and the second subpixel electrode 130, that is, a width W of the slit H2, may be about 3 μm or less.

Although the pixel electrode PE1 is illustrated as including one first subpixel electrode 140 and one second subpixel electrode 130, the pixel electrode PE1 may include a plurality of first subpixel electrodes and a plurality of second subpixel electrodes that are repeatedly arranged in one direction, for example, a vertical direction in the drawings. In this case, the trunk electrode 146 of the first subpixel electrode 140 may be formed at each of two corners that are arranged in a direction perpendicular to the one direction.

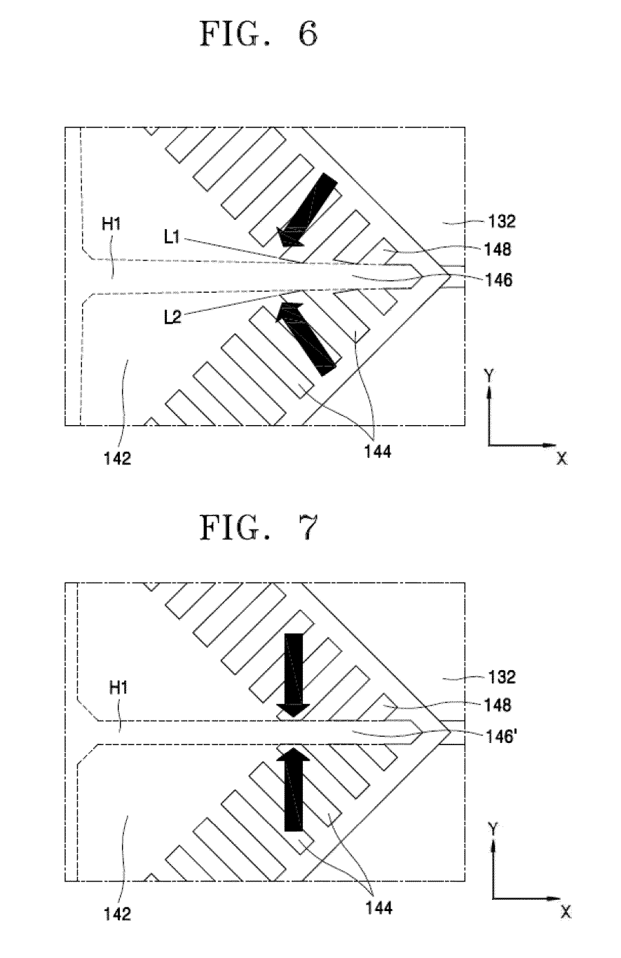

The above electrode structure, particularly, the shape of the pixel electrode PE1, is presented to reduce a texture. The inclined trunk surface 146a is introduced in a minute slit structure of the first subpixel electrode 140 to which a high voltage is applied, to reduce a strong fringe field generated due to a disposition relation with the cross-type opening pattern H1 formed in the common electrode CE1, to reduce a texture. This will be described later in detail with reference to FIGS. 6 to 9.

A detailed configuration of the LCD apparatus 1000 will be described below with reference to FIG. 1.

A thin film transistor (TFT) array layer 120 and the pixel electrode PE1 are formed on the first substrate 100. The TFT array layer 120 includes a plurality of switching devices TFT and also includes a plurality of gate lines and a plurality of data lines (not illustrated).

The first substrate 100 may be a glass substrate or a plastic substrate including polyethylen terephthalate (PET), polyethylen naphthalate (PEN), polyimide, or the like.

The switching device TFT is a thin film transistor and includes an active layer AT, a gate electrode GE, a source electrode SE, and a drain electrode DE.

A first insulating layer Ill, which is a gate insulating layer, is formed on the gate electrode GE, and the active layer AT is formed on the first insulating layer ILL On the active layer AT, the source electrode SE and the drain electrode DE are formed spaced apart from each other and a second insulating layer IL2 is formed to cover the source electrode SE and the drain electrode DE.

The active layer AT may include various materials. For example, the active layer AT may include an inorganic semiconductor material such as amorphous silicon or crystalline silicon. As another example, the active layer AT may include an oxide semiconductor material. As another example, the active layer AT may include an organic semiconductor material.

The gate electrode GE, the source electrode SE, and the drain electrode DE may be formed to have a single-layer structure or a multilayer structure including at least one metal selected from the group consisting of aluminum (Al), platinum (Pt), palladium (Pd), silver (Ag), magnesium (Mg), gold (Au), nickel (Ni), neodymium (Nd), iridium (Ir), chrome (Cr), lithium (Li), calcium (Ca), molybdenum (Mo), titanium (Ti), tungsten (W), and copper (Cu).

The first insulating layer IL1 and the second insulating layer IL2 may be formed of various types of insulating materials. The first insulating layer IL1 and the second insulating layer IL2 may be formed to have a single-layer structure or a multilayer structure including at least one insulating material selected from the group consisting of SiO₂, SiNₓ, SiON, Al₂O₃, TiO₂, Ta₂O₅, HfO₂, ZrO₂, BST, and PZT.

The pixel electrode PE1 is formed on the TFT array layer 120 such that the pixel electrode PE1 is connected to the switching device TFT. An alignment layer (not illustrated) may be formed on the pixel electrode PE1.

A light-blocking pattern BP, a color filter CF, an overcoating layer OC, and the common electrode CE1 are formed on the second substrate 500, and an alignment layer (not illustrated) may be further formed thereon. The second substrate 500 may be a glass substrate or a transparent plastic substrate, and an outer surface of the second substrate 500 is a display surface.

The light-blocking pattern BP is disposed on the second substrate 500 at a position corresponding to a region in which the switching device TFT, gate lines (not illustrated), and data lines (not illustrated) are formed, to block light. The above disposition of the light-blocking pattern BP is merely exemplary, and the light-blocking pattern BP may be disposed on the first substrate 100.

The color filter CF is disposed on the second substrate 500 to filter color light. The above disposition of the color filter CF is merely exemplary, and the color filter CF may be disposed on the first substrate 100.

The overcoating layer OC is disposed on the second substrate 500, on which the color filter CF is formed, to planarize a top surface of the second substrate 500. Alternatively, the overcoating layer OC may not be formed.

The common electrode CE1 is disposed on the second substrate 500 to face the pixel electrode PE1, and a reference voltage (i.e., a common voltage) defining the polarity of a voltage applied to the pixel electrode PE1 is applied to the common electrode CE1.

The liquid crystal layer 300 includes liquid crystal molecules. When a voltage is not applied between the common electrode CE1 and the pixel electrode PE1, that is, when an electric field is not formed in the liquid crystal layer 300, the liquid crystal molecules may be aligned vertically with respect to the first substrate 100 and the second substrate 500. The liquid crystal molecules may have negative dielectric anisotropy.

Polarizers may be disposed on the outer surfaces of the first substrate 100 and the second substrate 500, and polarization axes thereof may be perpendicular to each other. However, embodiments of the present invention are not limited thereto.

As illustrated in FIG. 4, the inclined trunk surface 146a is introduced in the minute slit of the first subpixel electrode 140 to reduce the generation of a texture in the LCD apparatus 1000.

FIG. 5 is an enlarged view of a partial region of a pixel electrode PE′ according to a comparative example.

Referring to FIG. 5, the pixel electrode PE′ of the comparative example is different from the pixel electrode PE1 of an embodiment of the present invention in terms of the shape of a trunk electrode 146′. A trunk surface 146a′ of the trunk electrode 146′ is parallel to the lengthwise direction of the cross-type opening pattern H1 formed in a common electrode. A region between the plurality of second branch electrodes 148 is a minute slit that has the trunk surface 146a′ parallel to the lengthwise direction of the cross-type opening pattern H1 as an end portion thereof.

A strong fringe field is formed in a region where such minute slit patterns vertically face each other.

FIG. 6 illustrates a direction of a fringe field generated in a local region of FIG. 4 in the LCD apparatus 1000 according to an embodiment of the present invention. FIG. 7 illustrates a direction of a fringe field generated in a local region of FIG. 5 by the pixel electrode PE′ according to the comparative example.

Referring to FIG. 7, the trunk electrode 146′ forms a strong fringe field with the cross-type opening pattern H1. Thus, a force applied to liquid crystal molecules is indicated by an arrow. Accordingly, the liquid crystal molecules disposed in such a region collide with each other due to different directions of strong forces applied thereto, thus causing a texture.

Referring to FIG. 6, due to the trunk surface 146a being inclined with respect to the lengthwise direction of the cross-type opening pattern H1, a region of the second branch electrode 148 forms a minute slit having such an inclined surface as an end portion thereof. A force caused by a fringe field formed by this structure and the cross-type opening pattern H1 is inclined in a substantially perpendicular direction with respect to lines L1 and L2 parallel to the trunk surface 146a. Accordingly, the collision of a liquid crystal director in this region may be reduced.

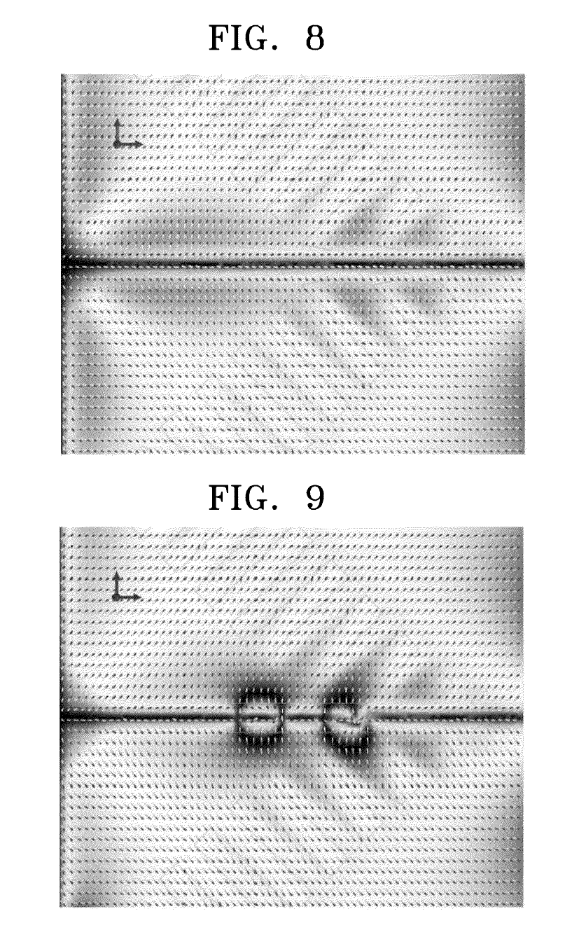

FIG. 8 illustrates a texture pattern generated in the local region of FIG. 4 in the LCD apparatus 1000 according to an embodiment of the present invention. FIG. 9 illustrates a texture pattern generated in the local region of FIG. 5 by the pixel electrode PE′ according to the comparative example.

Referring to FIGS. 8 and 9, it may be seen that a texture in a relevant region is reduced when the inclined trunk surface 146a is introduced in the pixel electrode PE1.

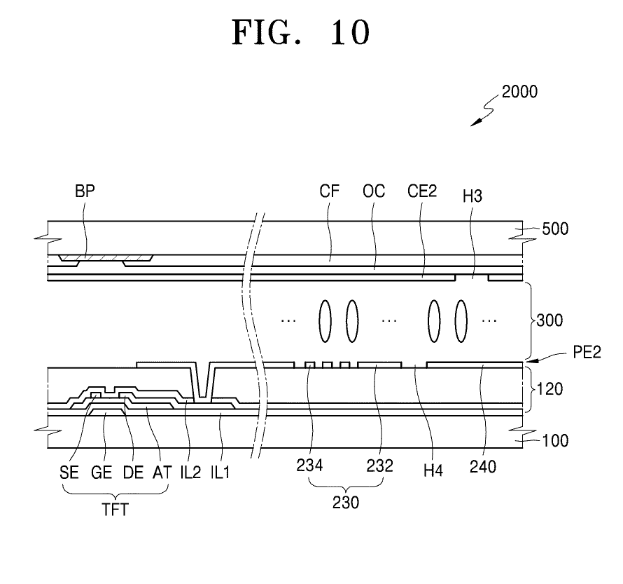

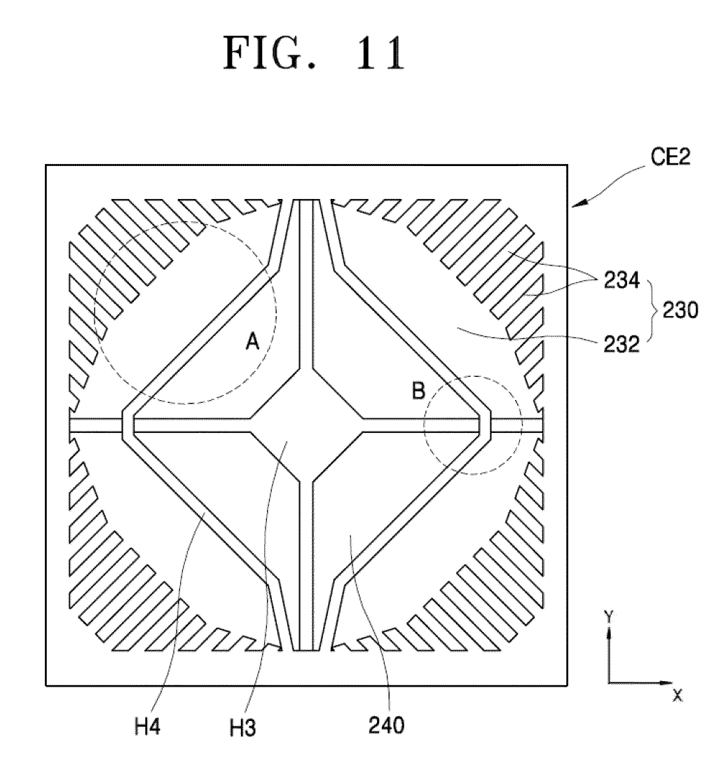

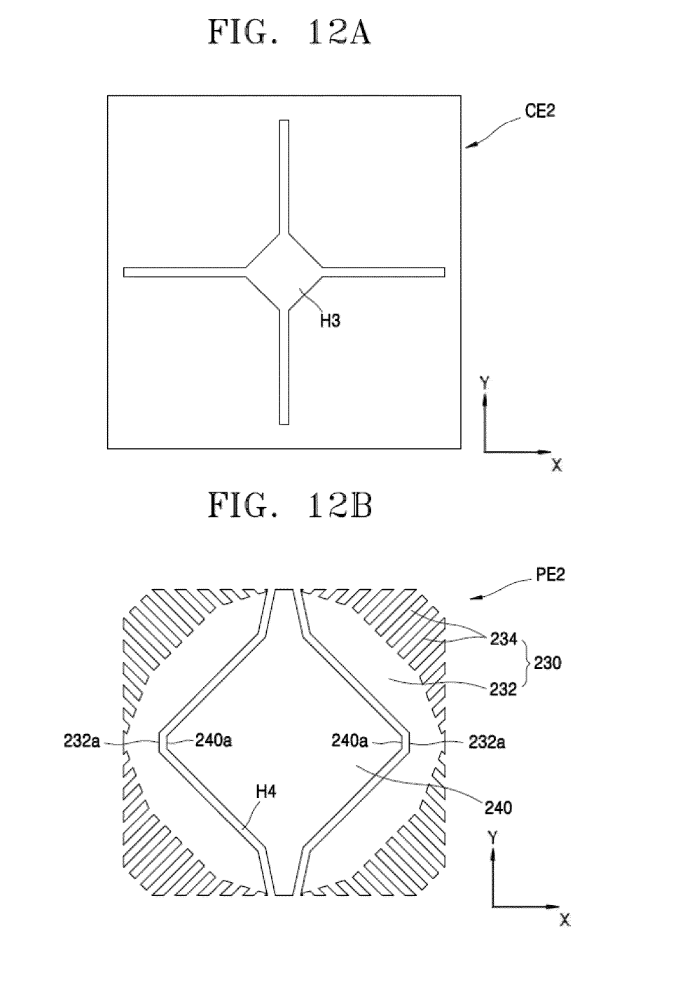

FIG. 10 is a cross-sectional view illustrating a schematic structure of a LCD apparatus 2000 according to another embodiment of the present invention. FIG. 11 is a plan view illustrating in detail an electrode structure of the LCD apparatus 2000 of FIG. 10. FIGS. 12A and 12B are plan views respectively illustrating a common electrode and a pixel electrode in the plan view of FIG. 11.

The LCD apparatus 2000 of the present embodiment is different from the LCD apparatus 1000 of FIG. 1 in terms of the detailed shapes of a common electrode CE2 and a pixel electrode PE2. Thus, only differences therebetween will be described, and redundant descriptions thereof will be omitted.

Referring to FIGS. 11 and 12A, a cross-type opening pattern H3 is formed in the common electrode CE2. A center portion of the cross-type opening pattern H3 may have a diamond shape as illustrated in FIGS. 11 and 12A, but is not limited thereto.

Referring to FIGS. 11 and 12B, the pixel electrode PE2 includes a first subpixel electrode 240 and a second subpixel electrode 230. A voltage lower than a voltage applied to the first subpixel electrode 240 is applied to the second subpixel electrode 230. For example, a first voltage, with reference to a reference voltage, is applied to the first subpixel electrode 240 of the pixel electrode PE2, and a second voltage, with reference to the same reference voltage, is applied to the second subpixel electrode 230 of the same pixel electrode PE2. The reference voltage of the first and second voltages may be applied to the common electrode CE2 of the same pixel. The first voltage is different from the second voltage. Here, the first voltage is greater than the second voltage. A method of dividing a pixel electrode into two subpixel electrodes and applying different voltages to the two subpixel electrodes as above is used to approximate lateral side visibility to front visibility. A spacing distance between the first subpixel electrode 240 and the second subpixel electrode 230 and a ratio between voltages applied to the first subpixel electrode 240 and the second subpixel electrode 230 may be adjusted to improve the lateral side visibility.

The first subpixel electrode 240 has the shape of a plate electrode, and a portion facing one end of the cross-type opening pattern H3 formed in the common electrode CE2 has a chamfered shape. As illustrated in FIG. 12B, a chamfered surface 240a is perpendicular to the lengthwise direction of the cross-type opening pattern H3. The chamfered surface 240a may be formed at two opposite corner portions.

The second subpixel electrode 230 forms a predetermined space with the first subpixel electrode 240 with a slit H4 interposed therebetween and surrounds the first subpixel electrode 240. The second subpixel electrode 230 includes: a plate electrode 232 forming a predetermined space with the first subpixel electrode 240 and surrounding the first subpixel electrode 240; and a plurality of branch electrodes 234 extending from an outer frame of the plate electrode 232.

A surface 232a of the second subpixel electrode 230, which faces the chamfered surface 240a of the first subpixel electrode 240, is parallel to the chamfered surface 240a.

A shape connecting the end portions of the plurality of branch electrodes 234 and the plate electrode 232 may be a chamfered quadrangle shape, but is not limited thereto.

The spacing distance between the first subpixel electrode 240 and the second subpixel electrode 230, that is, a width of the slit H4, may be about 3 μm or less.

Although the pixel electrode PE2 is illustrated as including one first subpixel electrode 240 and one second subpixel electrode 230, the pixel electrode PE2 may include a plurality of first subpixel electrodes and a plurality of second subpixel electrodes that are repeatedly arranged in one direction, for example, a vertical direction in the drawings. In this case, the chamfered surface 240a of the first subpixel electrode 240 may be formed at each of two corners that are arranged in a direction perpendicular to the one direction.

The electrode structure illustrated in FIG. 11, particularly, the shape of the pixel electrode PE2 is presented to reduce a texture.

The shape of a portion A illustrated in FIG. 11 is to reduce a texture that may be generated in a region where the first subpixel electrode 140 and the second subpixel electrode 130 face each other in the pixel electrode PE1 of FIG. 2.

FIG. 13A is an enlarged view of a partial region of FIG. 2. FIG. 13B is a cross-sectional view taken along an indication line of FIG. 13A, which illustrates a direction of a force applied to the liquid crystal layer 300.

Referring to FIG. 13B, F1 and F2 denote forces that are applied to liquid crystal molecules by an electric field formed between the common electrode CE1 and the pixel electrode PE1. The liquid crystal molecules are inclined in the directions of the forces. In this case, the force F1 is directed to control the liquid crystal molecules, and the force F2 is directed to obstruct liquid crystal control. Forces having such directions are generated in a region where the second plate electrode 132 to which a low voltage is applied and the first branch electrode 144 to which a high voltage is applied are adjacent to each other. A voltage lower than a voltage applied to the first subpixel electrode 140 is applied to the second subpixel electrode 130. That is, a first voltage, with reference to a reference voltage, is applied to the first subpixel electrode 140 of the pixel electrode PE1, and a second voltage, with reference to the same reference voltage, is applied to the second subpixel electrode 130 of the same pixel electrode PE1. The reference voltage of the first and second voltages may be applied to the common electrode CE1 of the same pixel. The first voltage is different from the second voltage. Here, the first voltage is greater than the second voltage. The second plate electrode 132 of the second subpixel electrode 130 and the first branch electrode 144 of the first subpixel electrode 140 face each other. In this case, since the second plate electrode 132 is much larger than the first branch electrode 144, a region, in which an electric field generated by the second plate electrode 132 to which a low voltage is applied is higher than an electric field generated by the first branch electrode 144 to which a high voltage is applied, is formed in the liquid crystal layer 300. The force F2 directed to obstruct liquid crystal control is formed in this region.

FIG. 14A is an enlarged view of a partial region A of FIG. 11. FIG. 14B is a cross-sectional view taken along an indication line of FIG. 14A, which illustrates a direction of a force applied to the liquid crystal layer 300.

As illustrated in FIG. 14B, when the first subpixel electrode 240 is changed into the shape of a plate electrode, since an electric field generated by the first subpixel electrode 240 is stronger than an electric field generated by the plate electrode 232 to which a low voltage is applied, a direction of F1 is maintained and a force having a direction of F2 illustrated in FIG. 13B is not generated.

The shape of a portion B illustrated in FIG. 11 is to reduce a texture. That is, the texture is greatly generated in this portion when the chamfered surfaces 240a and 232a are not formed in a portion of the first subpixel electrode 240 and a portion of the plate electrode 232 of the second subpixel electrode 230, the portions facing one end of the cross-type opening pattern H3.

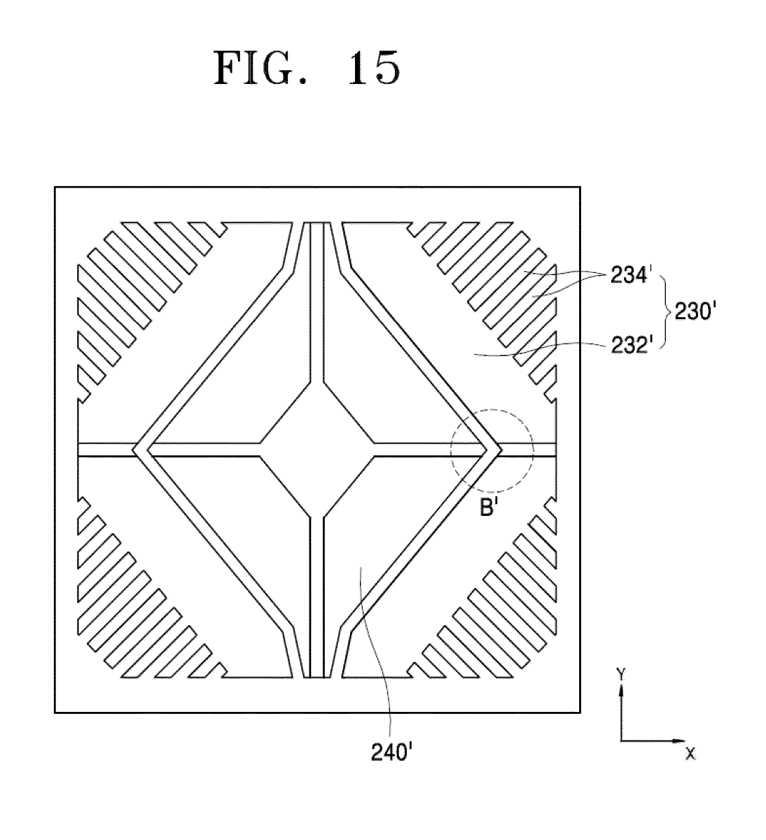

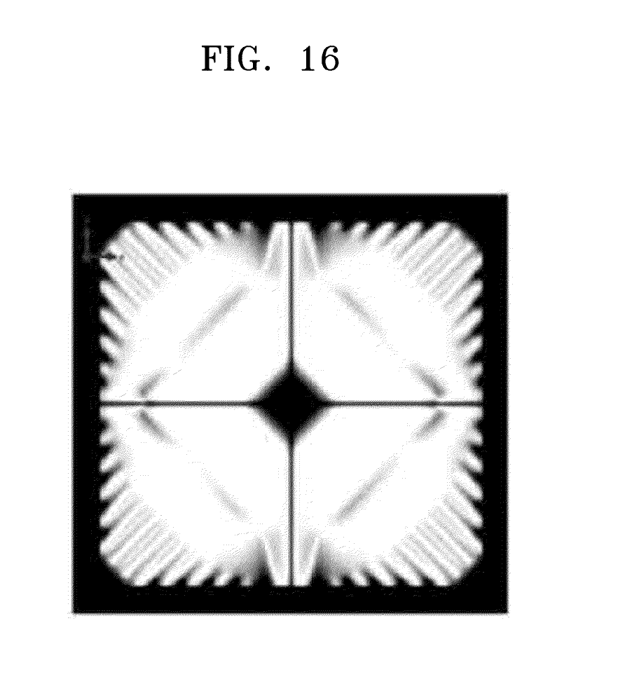

FIG. 15 is a plan view illustrating an electrode structure of a LCD apparatus according to a comparative example.

Unlike in the electrode structure of FIG. 12B, in the electrode structure of FIG. 15, a portion of a first subpixel electrode 240′ and a portion of a plate electrode 232′ of a second subpixel electrode 230′, which face one end of the cross-type opening pattern H3, have a pointed shape. A texture may be generated to a large degree in a portion indicated by a dotted circle B′.

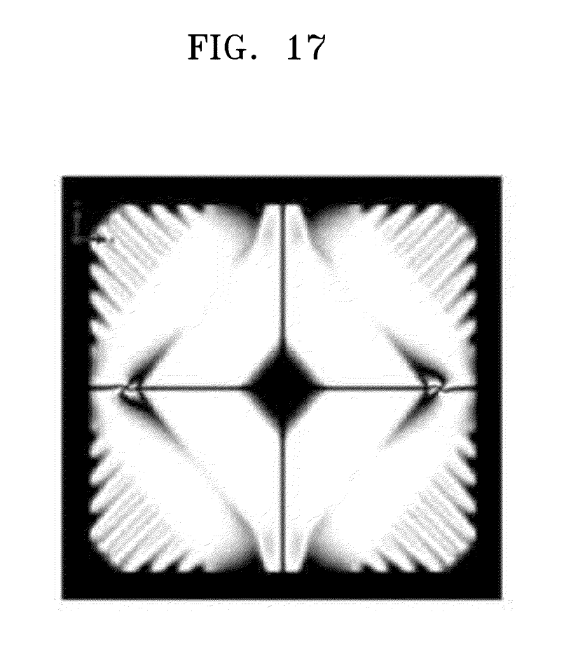

FIG. 16 illustrates a texture pattern generated in the LCD apparatus 2000 of FIG. 10. FIG. 17 illustrates a texture pattern generated by the electrode structure of FIG. 15 in the LCD apparatus according to the comparative example.

Referring to FIGS. 16 and 17, it may be seen that some texture is generated in the neighborhood of the regions B and B′ of FIGS. 11 and 15 in both the embodiment and the comparative example but a texture is significantly reduced in the embodiment.

As described above, according to the one or more of the above embodiments of the present invention, the LCD may form a high-quality image with a reduced texture and an improved transmittance.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A liquid crystal display (LCD) apparatus, comprising:
a first substrate on which a pixel electrode comprising a first subpixel electrode and a second subpixel electrode, which forms a predetermined space with the first subpixel electrode and surrounds the first subpixel electrode, is formed;
a second substrate on which a common electrode having a cross-type opening pattern is formed; and
a liquid crystal layer disposed between the first substrate and the second substrate, a first voltage applied to the first subpixel electrode being greater than a second voltage applied to the second subpixel electrode, with reference to a same reference voltage, and
the first subpixel electrode comprising:
a first plate electrode;
a plurality of first branch electrodes protruding from sides of the first plate electrode;
a trunk electrode extending from a corner of the first plate electrode in a lengthwise direction of the cross-type opening pattern and having a trunk surface that faces one end portion of the cross-type opening pattern and is inclined at a predetermined angle with respect to the lengthwise direction; and
a plurality of second branch electrodes protruding from both sides of the trunk electrode.

2. The LCD apparatus of claim 1, wherein the trunk electrode is provided in a plurality and is formed at each of opposite corners of the first plate electrode.

3. The LCD apparatus of claim 1, wherein
the pixel electrode is repeatedly arranged in one direction, and
the trunk electrode is formed at each of corners that are arranged in a direction perpendicular to the one direction.

4. The LCD apparatus of claim 1, wherein the second subpixel electrode comprises:
a second plate electrode forming a predetermined space with the first subpixel electrode and surrounding the first subpixel electrode; and
a plurality of third branch electrodes extending from an outer frame of the second plate electrode.

5. The LCD apparatus of claim 4, wherein a shape connecting end portions of the plurality of third branch electrodes and the second plate electrode is a chamfered quadrangle shape.

6. The LCD apparatus of claim 1, wherein a center portion of the cross-type opening pattern forms a diamond-type opening.

7. The LCD apparatus of claim 1, wherein the predetermined space is about 3 μm or less.

8. The LCD apparatus of claim 1, wherein a shape connecting end portions of the plurality of first branch electrodes, the trunk electrode, and the plurality of second branch electrodes is a diamond shape.

9. The LCD apparatus of claim 1, wherein the predetermined angle is not equal to zero or 180°.

10. A liquid crystal display (LCD) apparatus, comprising:
a first substrate on which a pixel electrode comprising a first subpixel electrode and a second subpixel electrode, which forms a predetermined space with the first subpixel electrode and surrounds the first subpixel electrode, is formed;
a second substrate on which a common electrode having a cross-type opening pattern is formed; and
a liquid crystal layer disposed between the first substrate and the second substrate,
a first voltage applied to the first subpixel electrode being greater than a second voltage applied to the second subpixel electrode, with reference to a same reference voltage, and
the first subpixel electrode comprising a first plate electrode, a portion of which facing one end of the cross-type opening pattern having a chamfered shape.

11. The LCD apparatus of claim 10, wherein a chamfered surface of the chamfered shape is perpendicular to a lengthwise direction of the cross-type opening pattern.

12. The LCD apparatus of claim 10, wherein the chamfered shape is formed at opposite corner portions of the first plate electrode.

13. The LCD apparatus of claim 10, wherein a center portion of the cross-type opening pattern has a diamond shape.

14. The LCD apparatus of claim 12, wherein
the pixel electrode is repeatedly arranged in one direction, and
the chamfered shape is formed at each of corner portions that are arranged in a direction perpendicular to the one direction.

15. The LCD apparatus of claim 10, wherein the second subpixel electrode comprises:
a second plate electrode forming a predetermined space with the first subpixel electrode and surrounding the first subpixel electrode; and
a plurality of branch electrodes extending from an outer frame of the second plate electrode.

16. The LCD apparatus of claim 15, wherein a portion of the second subpixel electrode, which faces a chamfered surface of the chamfered shape of the first subpixel electrode, is parallel to the chamfered surface.

17. The LCD apparatus of claim 15, wherein a shape connecting end portions of the plurality of branch electrodes and the second plate electrode is a chamfered quadrangle shape.

18. The LCD apparatus of claim 10, wherein the predetermined space is about 3 μm or less.
